(19) United States
(12) Patent Application Publication
(10) Pub. No.: US 2009/0090219 A1
(43) Pub. Date: Apr. 9, 2009

(54) SCREWDRIVER EXTENSION

(75) Inventors: LI-CHIN LU, Tu-Cheng (TW); JIAN-HUA XIANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (Shenzhen) CO., LTD, Shenzhen City (CN); HON HAI PRECISION INDUSTRY CO., LTD., Tu-Cheng (TW)

(21) Appl. No.: 12/138,431

(22) Filed: Jun. 13, 2008

(30) Foreign Application Priority Data
Oct. 8, 2007 (CN) 200710201946.4

(51) Int. Cl. B25B 21/00; B25B 23/02

(52) U.S. Cl. 81/57; 81/451

(57) ABSTRACT

A screwdriver extension includes a supporting plate, a transferring part, a transmission shaft, and a receiving sleeve. The transferring part includes a housing and a plurality of meshed gears mounted in the housing. The supporting plate connects the transferring part to an electric screwdriver. The transmission shaft is driven by the electric screwdriver and drives the gears, which in turn drives the receiving sleeve. The sleeve receives a screwdriver head. The screwdriver extension helps the electric screwdriver to tighten screws along axes of corresponding holes.

### BACKGROUND

1. Technical Field

The present invention relates to a screwdriver extension for facilitating the fixing of screws in an object.

2. General Background

Screwdrivers are usually used to tighten screws during the assembly of electronic products. But under certain circumstances, it is hard to tighten screws due to the screw holes' hard-to-reach locations. For example, referring to FIG. 5, a notebook computer's main body 10 is shown. The main body 10 includes a battery case 11. Referring also to FIG. 6, some holes 12 are defined in the walls of the battery case 11 for receiving screws 30. An electric screwdriver 20 is used to tighten the screws 30 into the holes 12. Because of the relatively small size of the battery case 11, and relatively bigger body size of the electric screwdriver 20, the electric screwdriver 20 must be tilted to tighten the screws 20. Thus the screws 30 cannot be tightened along axes of the holes 12.

Thus, what is needed is a device which helps tighten screws along axes of corresponding holes.

### SUMMARY

A screwdriver extension is disclosed. The screwdriver extension includes a supporting plate, a transferring part, a transmission shaft, and a receiving sleeve. The transferring part includes a housing, and a plurality of meshed gears mounted in the housing. The supporting plate connects the transferring part to an electric screwdriver. The transmission shaft is driven by the electric screwdriver and drives the gears, which in turn drive the receiving sleeve. The sleeve is capable of receiving a screwdriver head.

Other advantages and novel features will become more apparent from the following detailed description of embodiments when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present screwdriver extension. Moreover, in the drawings, like reference numerals designate corresponding parts throughout the several views.

FIG. 1 is an abbreviated, isometric view of a screwdriver extension for a screw according to an exemplary embodiment of the present invention, showing the screwdriver extension mounted on an electric screwdriver.

FIG. 2 is an enlarged, isometric view of a part of the screwdriver extension of FIG. 1.

FIG. 3 is a cross-sectional view of the part of the screwdriver extension of FIG. 2.

FIG. 4 is an abbreviated, side plan view of the screwdriver extension and electric screwdriver of FIG. 1 being used to install a screw in a main body of a notebook computer, the main body being shown in cross-section.

FIG. 5 is an isometric view of a main body of a conventional notebook computer.

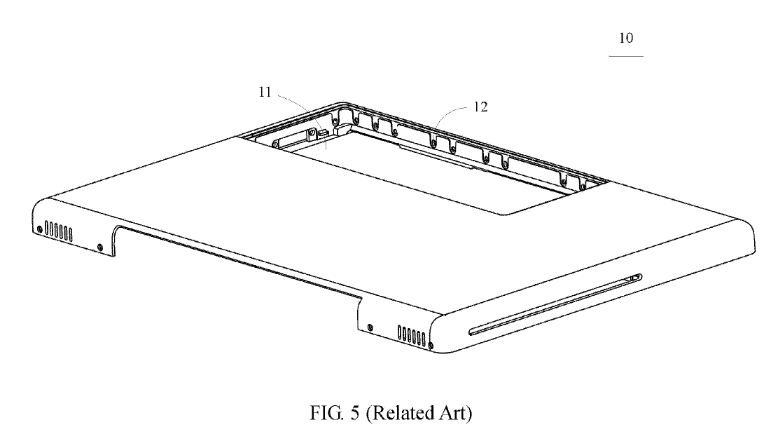

FIG. 6 is a side cross-sectional view of the main body of FIG. 5, showing a screw being installed therein with an electric screwdriver.

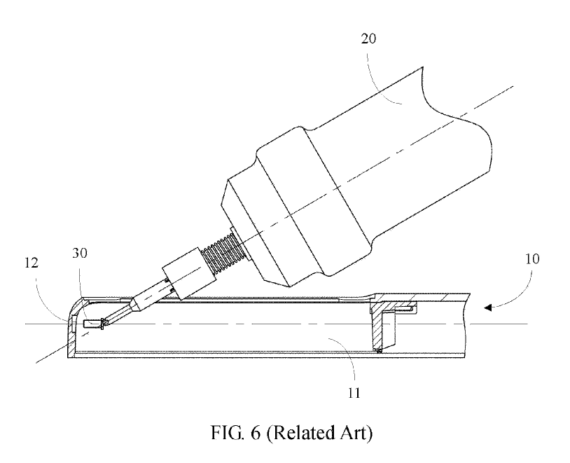

### DETAILED DESCRIPTION OF THE EMBODIMENT

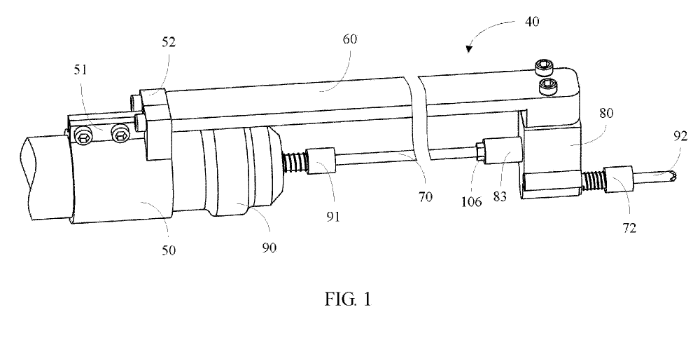

Referring to FIG. 1, a screwdriver extension 40 according to an exemplary embodiment of the present invention is shown. The screwdriver extension 40 is mounted on an electric screwdriver 90. The screwdriver extension 40 includes a pair of mounting bushings 50, a supporting plate 60, a transmission shaft 70, a transferring part 80, and a receiving sleeve 72.

Cross-sections of the mounting bushings 50 are C shaped. The mounting bushings 50 surround a middle portion of the electric screwdriver 90. Two first fixing portions 51 are elongated at top ends of the mounting bushing 50 and are adjacent to each other. Screws (not labeled) are used to fix the two first fixing portions 51, thus connecting the mounting bushings 50 to the electric screwdriver 90. Two second fixing portions 52 extend from the top ends of the mounting bushings 50. The second fixing portions 52 are perpendicular to the first fixing portions 51. The second fixing portions 52 are connected to an end of the supporting plate 60 by screws. The other end of the supporting plate 60 is connected to the transferring part 80 with screws (not labeled).

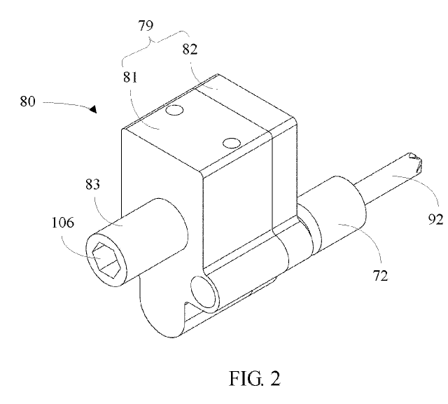

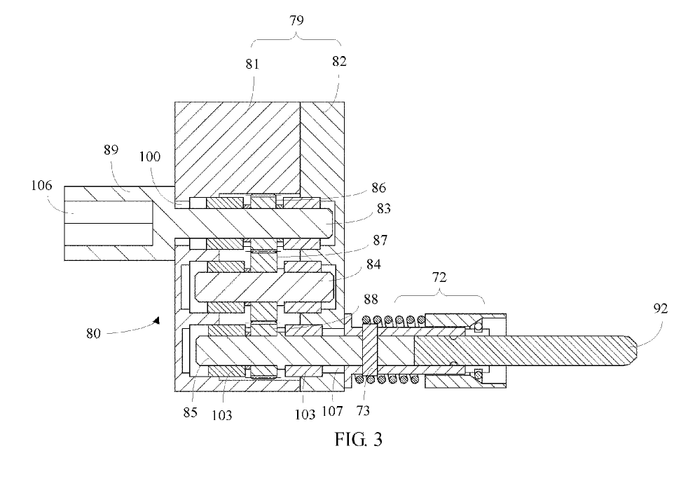

Referring to FIGS. 2 and 3, the transferring part 80 includes a housing 79, gears 86, 87, 88, and shafts 83, 84, 85. The gears 86, 87, 88 and the shafts 83, 84, 85 are received in the housing 79. The housing 79 includes shells 81, 82 connected to each other by screws (not shown). The gears 86, 87, 88 are respectively supported by the shafts 83, 84, 85. The shafts 83, 84, 85 are rotatably mounted in the housing 79 with shaft bushings 103. The gears 86, 87, 88 are meshed to each other in that order.

The shaft 83 includes a shaft end 89. The shell 81 defines a hole 100. The shaft 83 extends through the hole 1 00 and is partly received in the shells 81, 82. The shaft end 89 projects out of the shell 81. The diameter of the shaft end 89 is bigger than that of the hole 1 00. The shaft end 89 defines a hole 1 06. The hole 1 06 is polygon shaped in cross section. Referring back to FIG. 3, two ends of the transmission shaft 70 are polygon shaped in cross section. The two ends of the transmission shaft 70 respectively extend into a receiving sleeve 91 of the electric screwdriver 90 and the hole 106 of the shaft 83, thus connecting the receiving sleeve 91 to the shaft 83.

The shell 82 defines a hole 1 07. The shaft 85 extends through the hole 1 07 and partly projects out of the shell 82.

The receiving sleeve 72 encloses the shaft 85, and is connected with the shaft 85 by a bolt 73. The receiving sleeve 72 is similar to a conventional receiving sleeve of an electric screwdriver, thus, a detailed description of the receiving sleeve 72 is omitted.

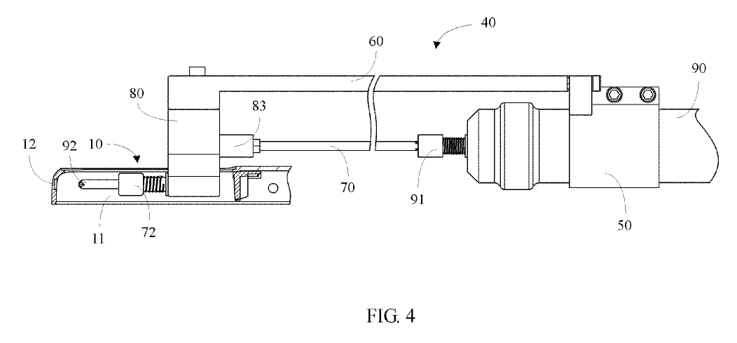

Referring to FIG. 4, a process of tightening screws in the notebook computer's main body 10 is as follows. First, the receiving sleeve 72 receives a screwdriver head 92. Second, a screw (not shown) is placed on the screwdriver head 92. Third, the screwdriver head 92 is held in the case 11 of the computer's main body 10, and the screw is aligned with the hole 12. Fourth, the electric screwdriver 90 is activated, and the receiving sleeve 91 drives the transmission shaft 70, the gears 86, 87, 88, the shaft 85, the receiving sleeve 72, and the screwdriver head 92 in turn, thus installing the screw and tightening it in along the axis of the hole 12.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A screwdriver extension comprising:
a transferring part comprising a housing and a plurality of meshed gears mounted in the housing;
a supporting plate configured for connecting the transferring part to an electric screwdriver;
a transmission shaft capable of being driven by the electric screwdriver and thereby driving the gears; and
a receiving sleeve configured to be driven by the gears, and capable of receiving a screwdriver head.

2. The screwdriver extension of claim 1, further comprising a pair of mounting bushings, which are configured to mount the supporting plate on the electric screwdriver.

3. The screwdriver extension of claim 1, wherein the plurality of meshed gears includes three meshed gears.

4. The screwdriver extension of claim 1, wherein the housing comprises two shells connected to each other.

5. The screwdriver extension of claim 1, wherein the supporting plate and the transmission shaft are elongated.
